(19) United States
(12) Patent Application Publication
(10) Pub. No.: US 2018/0013191 A1
(43) Pub. Date: Jan. 11, 2018

(54) ELECTRONIC DEVICE WITH ENERGY ABSORBING/REFLECTING LAYER

(71) Applicant: LunaTech, LLC, Encino, CA (US)

(72) Inventors: John David Cameron, Encino, CA (US); Dean Becker, Fairhope, AL (US); Gene Fein, Oxnard, CA (US)

(21) Appl. No.: 15/647,040

(22) Filed: Jul. 11, 2017

Related U.S. Application Data
(60) Provisional application No. 62/360,691, filed on Jul. 11, 2016.

(51) Int. Cl. H01Q 1/24; H01Q 1/52; H01Q 17/00; H04M 1/02; H01Q 1/42

(52) U.S. Cl. CPC H01Q 1/245; H04M 1/0249; H04B 1/3833; H01Q 1/42; H01Q 17/001; H01Q 1/526; H01Q 17/007

(57) ABSTRACT

The present disclosure is directed to an apparatus having an energy absorbing and/or reflecting layer. In one embodiment, the apparatus may include a display comprising at least one rigid transparent member having a composite energy/safety layer disposed thereon. The composite energy/safety layer may comprise a flexible, transparent plastic substrate layer having a carrier surface and an opposing back surface, and a multilayer energy control coating disposed on the carrier surface of the substrate layer, wherein the substrate layer and the multilayer energy control coating define an energy control film. At least one flexible, transparent, energy absorbing plastic safety layer may be bonded to a surface of the energy control film. The multilayer energy control coating may be configured to absorb and/or reflect energy in and below the Gigahertz frequency range and to minimize energy absorption and reflection in the Terahertz frequency range.

### CROSS-REFERENCE TO RELATED APPLICATION

This application claims the benefit of U.S. Provisional Application No. 62/360,691, filed on Jul. 11, 2016, entitled “Electronic Device with Energy Absorbing/Reflecting Layer”, the contents of which are incorporated herein by reference as though set forth in their entirety.

### BACKGROUND

The presence of electronic devices is becoming increasingly widespread; thus, the potential for exposure to such devices is more commonplace. Electronic devices, especially devices with wireless capabilities, tend to emit electromagnetic energy into the surrounding space. There is concern that exposure to these electromagnetic emissions for an extended period has the potential to result in adverse health effects. One particular example includes prevalence of mobile phones and their constant use in close proximity with our bodies. These health concerns are not limited just to mobile phones, and extend to a number of other electronic devices.

It would be desirable, therefore, to develop new technologies for such applications, that overcome these and other limitations of the prior art, and that enhance the utility of mobile phone equipment.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an electronic device having an energy absorbing and/or reflecting layer. In one embodiment, there may be provided an apparatus having a display comprising at least one rigid transparent member, wherein the at least one transparent member has a composite energy/safety layer disposed thereon. The composite energy/safety layer may comprise a flexible, transparent plastic substrate layer having a carrier surface and an opposing back surface, and a multilayer energy control coating disposed on the carrier surface of the substrate layer, wherein the substrate layer and the multilayer energy control coating define an energy control film. At least one flexible, transparent, energy absorbing plastic safety layer may be bonded to a surface of the energy control film. The multilayer energy control coating may be configured to absorb and/or reflect energy in and below the Gigahertz frequency range and to minimize energy absorption and reflection in the Terahertz frequency range. The apparatus may further comprise an energy emitting component configured for emitting energy in and below the Gigahertz range, wherein at least a portion of the emitted is absorbed and/or reflected by the composite energy/safety film.

In accordance with the embodiments disclosed herein, there may be provided an electronic device. The electronic device may comprise a housing configured to at least partially surround the electronic device, a multi-layered display disposed within the housing, wherein the multi-layered display may be configured to display images thereon, and at least one energy absorbing/reflecting layer affixed to at least a portion of the multi-layered display. The at least one energy absorbing/reflecting layer may be comprised of a flexible, transparent substrate layer comprising a carrier surface and an opposing back surface, a multilayer energy control coating disposed on the carrier surface, wherein the multilayer energy control coating may be configured to absorb and/or reflect at least a portion of energy within or below a Gigahertz frequency range, and minimize energy absorption and/or reflection in a Terahertz frequency range, and at least one flexible, transparent, energy absorbing safety layer disposed on at least one of the back surface of the substrate layer, the multilayer energy control coating, and combinations thereof. The electronic device may further comprise at least one energy emitting component disposed within the housing behind the multi-layered display, wherein the at least one energy emitting component may be configured to emit energy within or below a Gigahertz frequency range. At least a portion of the energy emitted from the at least one energy emitting component may be absorbed and/or reflected by the at least one energy absorbing/reflecting layer.

In one embodiment, the multi-layered display may comprise at least one light-generating layer, a touch-sensitive layer, and a cover layer. In one embodiment, the at least one energy absorbing/reflecting layer may be affixed to at least a portion of the cover layer of the multi-layered display.

In one embodiment, the multilayer energy control coating may comprise at least one layer of a metallic material. The at least one layer of metallic material may be selected from the group consisting of silver, palladium, aluminum, chromium, nickel, copper, gold, brass, stainless steel, and alloys thereof, and combinations thereof.

In another embodiment, the multilayer energy control coating may comprise at least one layer of dielectric material. The at least one layer of dielectric material may be selected from the group consisting of ZrO2, Ta2O5, WO3, In2O3, SnO2, In/SnOx, Al2O3, ZnS, ZnO, and TiO2.

In one embodiment, the multilayer energy control coating may comprise at least three layers, wherein the three layers may be configured as a first layer of dielectric material, a layer of metallic material, and a second layer of dielectric material. In another embodiment, the multilayer energy control coating may comprise at least five layers, wherein the five layers may be configured as a first layer of dielectric material, a first layer of metallic material, a second layer of dielectric material, a second layer of metallic material, and a third layer of dielectric material.

In one embodiment, the transparent substrate layer may be selected from the group consisting of biaxially oriented polyesters, nylons, polyurethanes, acrylics, polycarbonates, polyolefins, cellulose acetates and triacetates, vinyl chloride polymers and copolymers, and combinations thereof. In another embodiment, the at least one safety layer may be selected from the group consisting of plasticized polyvinyl butyral, polyurethanes, polyvinyl chloride, polyvinyl acetal, polyethylene, ethylene vainly acetates, and combinations thereof.

In accordance with the embodiments disclosed herein, there may be provided an apparatus. The apparatus may comprise a multi-layered display configured to display images thereon, wherein the multi-layered may comprise a cover layer comprising at least one transparent region and at least one opaque region, a touch-sensitive layer positioned behind at least one transparent region of the cover layer, and a light-generating layer affixed behind the touch-sensitive layer. The apparatus may further comprise at least one energy emitting component positioned behind the light-generating layer, wherein the at least one energy emitting component may be configured to emit energy within or below a Gigahertz frequency range. The apparatus may also comprise at least one energy absorbing/reflecting layer positioned between the cover layer and at least one energy-emitting component, wherein at least a portion of the energy emitted from the at least one energy emitting component may be absorbed and/or reflected by the at least one energy absorbing/reflecting layer.

In one embodiment, at least one energy absorbing/reflecting layer may be positioned between the light-generating layer and at least one energy-emitting component. The at least one energy absorbing/reflecting layer may minimize absorption and/or reflection of energy in the 430 to 770 Terahertz range. In another embodiment, the at least one energy absorbing/reflecting layer absorbs and/or reflects a specific type of energy.

In one embodiment, the light-generating layer may comprise a liquid crystal display. In another embodiment, the light-generating layer may comprise an organic light-emitting diode display. In another embodiment, the at least one energy emitting component may be a printed circuit board.

In accordance with the embodiments disclosed herein, there may be provided an apparatus. The apparatus may a cover layer comprising at least one transparent region and at least one opaque region, a display layer positioned behind at least one transparent region of the cover layer, and a light-generating layer affixed behind the display layer. The apparatus may further comprise at least one energy emitting component positioned behind the light-generating layer, wherein the at least one energy emitting component may be configured to emit energy within or below a Gigahertz frequency range. The apparatus may also comprise at least one energy absorbing/reflecting layer positioned between the display layer and at least one energy-emitting component, wherein at least a portion of the energy emitted from the at least one energy emitting component may be absorbed and/or reflected by the at least one energy absorbing/reflecting layer.

In one embodiment, the at least one energy absorbing/reflecting layer may comprise a flexible, transparent substrate layer comprising a carrier surface and an opposing back surface, a multilayer energy control coating disposed on the carrier surface, wherein the multilayer energy control coating may be configured to absorb and/or reflect at least a portion of energy within or below a Gigahertz frequency range, and minimize energy absorption and/or reflection in a Terahertz frequency range, and at least one flexible, transparent, energy absorbing safety layer disposed on at least one of the back surface of the substrate layer, the multilayer energy control coating, and combinations thereof.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 illustrates a perspective view of one embodiment of an electronic device with an energy absorbing/reflecting layer according to some embodiments.

FIG. 2 is a schematic diagram of one embodiment of an electronic device according to some embodiments.

FIG. 3 is a cross-sectional view of one embodiment of an electronic device having an energy absorbing/reflecting layer according to some embodiments.

FIG. 4 is an exploded view of one embodiment of a set of display layers used to form a display of an electronic device according to some embodiments.

FIG. 5 is a cross-sectional view of a portion of one embodiment of an electronic device having an energy absorbing/reflecting layer attached to an interior surface of the display according to some embodiments.

FIG. 6 is a cross-sectional view of a portion of one embodiment of an electronic device having an energy absorbing/reflecting layer attached to an interior surface of the display according to some embodiments.

FIG. 7 is a cross-sectional view of a portion of one embodiment of an electronic device having an energy absorbing/reflecting layer attached to an interior surface of the display according to some embodiments.

FIG. 8 is a cross-sectional view of a portion of one embodiment of an electronic device having an energy absorbing/reflecting layer attached to an interior surface of the display according to some embodiments.

FIG. 9 illustrates a cross-sectional view of one embodiment of an energy absorbing/reflecting layer according to some embodiments.

FIG. 10 illustrates an enlarged view of a section of one embodiment of an energy absorbing/reflecting layer according to some embodiments.

FIG. 11 illustrates an enlarged view of a section of one embodiment of an energy absorbing/reflecting layer according to some embodiments.

FIG. 12 illustrates a cross-sectional view of one embodiment of an energy absorbing/reflecting layer according to some embodiments.

FIG. 13 is a schematic diagram of one embodiment of an apparatus for forming the energy absorbing/reflecting layer according to some embodiments.

FIG. 14 illustrates an exemplary method for assembling an electronic device having an energy absorbing/reflecting layer according to some embodiments.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signifimayt both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In various implementations, there may be provided an apparatus having an energy absorbing and/or reflecting layer. In one embodiment, there may be provided an apparatus having a display comprising at least one rigid transparent member, wherein the at least one transparent member has a composite energy/safety layer disposed thereon. The composite energy/safety layer may comprise a flexible, transparent plastic substrate layer having a carrier surface and an opposing back surface, and a multilayer energy control coating disposed on the carrier surface of the substrate layer, wherein the substrate layer and the multilayer energy control coating define an energy control film. At least one flexible, transparent, energy absorbing plastic safety layer may be bonded to a surface of the energy control film. The multilayer energy control coating may be configured to absorb and/or reflect energy in and below the Gigahertz frequency range and to minimize energy absorption and reflection in the Terahertz frequency range. The apparatus may further comprise an energy emitting component configured for emitting energy in and below the Gigahertz range, wherein at least a portion of the emitted is absorbed and/or reflected by the composite energy/safety film.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

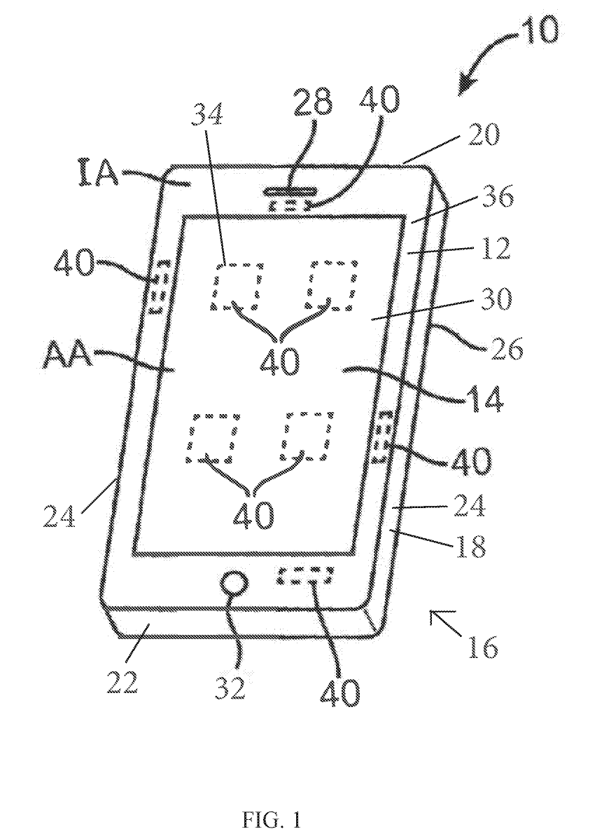

FIG. 1 shows an illustrative configuration for an electronic device 10. The electronic device 10 may be any type of electronic device that requires interactivity with a user of the device, including various types of cell phones, smart phones, satellite phones, MP3 players, video players, walkie talkies, GPS navigational devices, telematics devices, pagers, monitors, personal data assistants, bar code scanners, electronic vaporizing devices, as well as various types of computers, including portable computers, laptop computers, handheld computers, tablet computers, and various hybrid devices that combine two or more of these functions. In addition, these devices may operate with only a touch screen interface, or with only a keyboard or other type of manual input, and are not limited to devices that include keyboards, buttons, or touchscreens.

In one embodiment, the electronic device 10 may have a front surface 12. The front surface 12 may comprise a display 14, which may include a capacitive sensing touch screen 30 or other type of interactive control panel. In other embodiments, the front surface of the electronic device may have a keyboard or buttons (not shown) along with, or in lieu of, a touch screen or other display. The electronic device may have a back surface 16, and together with the front surface 12, the electronic device may be surrounded by a perimeter portion 18.

The perimeter portion 10, which may include a top surface 20, a bottom surface 22, and opposing side surfaces 24. The perimeter portion 18 along with the front surface 12 and the back surface 16 may provide the housing 26 of the electronics, battery, and other components of the electronic device. The side surfaces 24, including the top surface 20 and bottom surface 22, may have additional features of the electronic device, including buttons, controls, and access points, that make the electronic device 10.

The electronic device 10 may have a main button 32 for assisting in controls on the touchscreen 30. In some embodiments, this main button 32, often called a home button, may be located on a peripheral area of the front surface 12 of the electronic device 10, outside of the area of the interactive touch screen 30. The home button 32 may be located along any portion of the display 14 on the front surface 12 of the electronic device 10 and in some embodiments, the home button 32 may be located at the bottom portion of the display 14.

The display 14 may have an exterior layer, such as a rigid transparent layer 34 that includes openings for buttons and controls. In some embodiments, peripheral portions of the display 14 are provided with a partially or completely opaque masking layer. As shown in FIG. 1, display 14 may be characterized by a central active region AA, in which an array of display pixels is used in displaying information for a user, such as touchscreen 30. An inactive region, such as border region IA, may surround active region AA. As shown in FIG. 1, for illustrative purposes only, active region AA, including touchscreen 30, may have a rectangular shape. Inactive region IA may have a rectangular ring shape that surrounds active region AA. In some embodiments, at least a portion of inactive region IA may be covered with a partially opaque masking layer 36, such as a layer of black (e.g., a polymer filled with carbon black), a layer of partially opaque metal, and the like. The masking layer 36 may partially hide components in the interior of the electronic device 10 from view by the user.

As shown in FIG. 1, at least one energy absorbing/reflecting layer 40 may be mounted or attached to at least a portion of display 14. The at least one energy absorbing/reflecting layer 40 may be attached to at least one of: at least a portion of the active region AA (including touchscreen 30), at least a portion of inactive region IA, one or more portions of active region AA, to one or more portions of inactive region IA, and combinations thereof. In one embodiment, the energy absorbing/reflecting layer 40 may be attached to at least a portion of the masking layer 36, which covers at least a portion of the inactive region IA.

The housing 16 formed by the front surface 12, back surface 16, and the perimeter portion 18, may be formed of any suitable material, such as plastic, glass, ceramics, carbon-fiber composites and other fiber-based composites, metal (e.g., machined aluminum, stainless steel, etc.), and the like, and combinations thereof. The housing 16 may be formed using a unibody construction, in which most or all of the housing 16 may be formed from a single structural element, or may be formed from multiple structures.

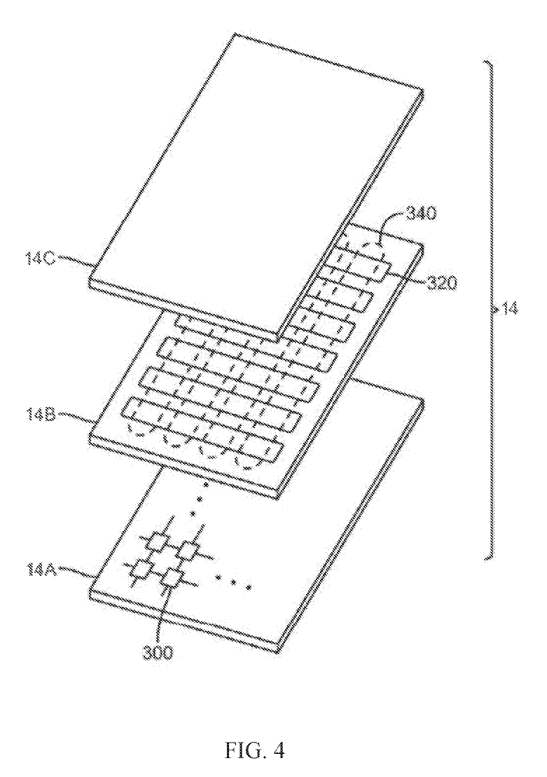

The display 14 may, in general, include image pixels formed from light-emitting diodes (LEDs), organic LEDs (OLEDs), plasma cells, electrowetting pixels, electrophoretic pixels, liquid crystal display (LCD) components, or other suitable image pixel structures. A display cover layer 14C as shown in FIG. 4, may cover at least a portion of the display 14, and may cover at least a portion of touchscreen 30. The display layer cover 14C may be formed from a transparent glass sheet, a clear plastic layer, or other transparent member.

In one embodiment, the energy absorbing/reflecting layer 40 may be laminated onto and/or within the display cover layer 14C. For example, the energy absorbing/reflecting layer 40 may comprise an encapsulated reflecting film. In a further embodiment, the display cover layer 14C may comprise a safety glass type of construction which is resistant to shatter upon impact. In such embodiment, the display cover layer 14C may comprise a laminated window assembly incorporating a flexible plastic safety film (e.g., polyvinyl butyral, PVB) between a pair of glass layers. A thin electrically-conductive metal coating may also be included in the display cover layer 14C. Thus, the display cover layer 14C, together with the energy absorbing/reflecting layer 40, may reflect energy (e.g., radio waves, micro waves, infrared waves, and the like) and optionally, conduct electricity for added capabilities. The energy absorbing/reflecting layer 40 may comprise a multilayer design with a number (e.g., three, five, seven or more) of functional coatings on a flexible plastic substrate or carrier layer such as polyethylene terephthalate (PET). The energy absorbing/reflecting layer 40 preferably may have good energy rejection characteristics and acceptably low visible distorted reflection images.

In one embodiment, the energy absorbing/reflecting layer 40 may be formed by a flexible plastic substrate, such as a PET film, having on one surface a multilayer energy coating. This multilayer energy coating may comprise at least one thin layer of metal and at least one adjacent adherent layer of a dielectric material. The energy coating may be deposited on the substrate, for example, by vacuum coating techniques. An energy absorbing safety film of the type normally used in shatterproof glass laminates (e.g., PVB) may be bonded to at least one side, and preferably both sides, of the energy control film to form a composite energy/safety film. This composite energy/safety film may be specially designed to contribute, after incorporation into a glass laminate, no more than about two percent of visible reflection (based on total incident visible radiation), which has the effect of substantially masking the visible effects of wrinkles in the energy control film substrate (i.e., the wrinkles are made less visible). This low level of visible reflection contribution may be achieved by careful control of the optical properties of the energy control film, the safety film, or both. Outer layer transparent glass panes may be laminated to one or both sides of the composite energy/safety film to provide a transparent member for use in the display cover layer 14C.

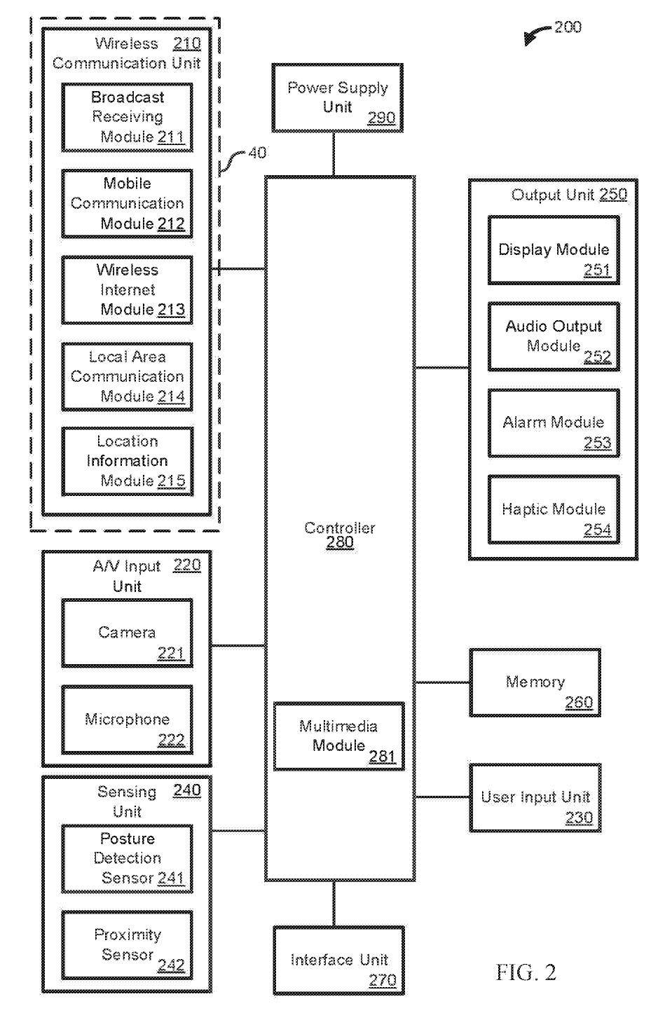

FIG. 2 is a block diagram of an electronic device 200 according to an embodiment. Other embodiments, configurations and arrangements may also be provided. As shown, the device 200 may include a wireless communication unit 210 (or radio communication unit), an audio/video (A/V) input unit 220, a user input unit 230, a sensing unit 240, an output unit 250, a memory 260, an interface 270, a controller 280, and a power supply unit 290.

The wireless communication unit 210 may include at least one module that enables radio communication between the device 200 and a radio communication system or between the device 200 and a network in which the device 200 is located. For example, the wireless communication unit 210 may include a broadcasting receiving module 211, a mobile communication module 212, a wireless Internet module 213, a local area communication module 214 (or local area network module), and a location information module 215 (or position information module).

The broadcasting receiving module 211 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals, but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 212.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 211 may receive broadcasting signals using various broadcasting systems. More particularly, the broadcasting receiving module 211 may receive digital broadcasting signals using digital broadcasting systems such as a digital multimedia broadcasting-terrestrial (DMB-T) system, a digital multimedia broadcasting satellite (DMB-S) system, a media forward link only (MediaFLO) system, a DVB-H, and integrated services digital broadcast-terrestrial (ISDB-T) systems. The broadcasting receiving module 211 may receive signals from broadcasting systems providing broadcasting signals other than the above-described digital broadcasting systems.

The broadcasting signals and/or broadcasting related information received through the broadcasting receiving module 211 may be stored in the memory 260. The mobile communication module 212 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 213 may correspond to a module for wireless Internet access and may be included in the device 200 or may be externally attached to the device 200. Wireless LAN (WLAN or Wi-Fi), wireless broadband (Wibro), world interoperability for microwave access (Wimax), high speed downlink packet access (HSDPA), and so on may be used as a wireless Internet technique.

The local area communication module 214 may correspond to a module for short range communication. Further, Bluetooth®, radio frequency identification (RFID), infrared data association (IrDA), ultra wideband (UWB) and/or ZigBee®. may be used as a short-range communication technique.

The location information module 215 may confirm or obtain a location or a position of the device 200. The location information module 215 may obtain position information by using a global navigation satellite system (GNSS). The GNSS is a terminology describing a radio navigation satellite system that revolves around the earth and transmits reference signals to predetermined types of radio navigation receivers such that the radio navigation receivers may determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 215. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module may continuously calculate a current position in real time and calculate velocity information using the location or position information.

The energy absorbing and/or reflecting layer 40 may be disposed within the device 200 to absorb and/or reflect energy released from the wireless communication unit 210, in particular one or more of the broadcasting receiving module 211, the mobile communication module 212, the wireless Internet module 213, the local area communication module 214, and/or the location information module 215.

The A/V input unit 220 may input (or receive) an audio signal and/or a video signal. The A/V input unit 220 may include a camera 221 and a microphone 222. The camera 221 may process image frames of still images or moving images obtained by an image sensor in a video telephony mode or a photographing mode. The processed image frames may be displayed on a display module 251, which may be a touch screen.

The image frames processed by the camera 221 may be stored in the memory 260 or may be transmitted to an external device through the wireless communication unit 210. The device 200 may also include at least two cameras 221.

The microphone 222 may receive an external audio signal in a call mode, a recording mode and/or a speech recognition mode, and the microphone 222 may process the received audio signal into electric audio data. The audio data may then be converted into a form that may be transmitted to a mobile communication base station through the mobile communication module 212 and output in the call mode. The microphone 222 may employ various noise removal algorithms (or noise canceling algorithm) for removing or reducing noise generated when the external audio signal is received.

The user input unit 230 may receive input data for controlling operation of the device 200 from a user. The user input unit 230 may include a keypad, a dome switch, a touch pad (constant voltage/capacitance), a jog wheel, a jog switch and/or so on.

The sensing unit 240 may sense a current state of the device 200, such as an open/close state of the device 200, a position of the device 200, whether a user touches the device 200, a direction of the device 200, and acceleration/deceleration of the device 200, and the sensing unit 240 may generate a sensing signal for controlling operation of the device 200. For example, in an example of a slide phone, the sensing unit 240 may sense whether the slide phone is opened or closed. Further, the sensing unit 240 may sense whether the power supply unit 190 supplies power and/or whether the interface unit 270 is connected to an external device. The sensing unit 240 may also include a proximity sensor 242. The sensing unit 240 may sense a motion of the device 200.

The output unit 250 may generate visual, auditory and/or tactile output, and the output unit 250 may include the display module 251, an audio output module 252, an alarm module 253 and a haptic module 254. The display module 251 may display information processed by the device 200. The display module 251 may display a user interface (UI) and/or a graphic user interface (GUI) related to a telephone call when the device 200 is in the call mode. The display module 251 may also display a captured and/or received image, a UI or a GUI when the device 200 is in the video telephony mode or the photographing mode.

The display module 251 may include at least one of a liquid crystal display, a thin film transistor liquid crystal display, an organic light-emitting diode display, a flexible display and/or a three-dimensional display. The display module 251 may be of a transparent type or a light transmissive type. That is, the display module 251 may include a transparent display.

The transparent display may be a transparent liquid crystal display. A rear structure of the display module 251 may also be of a light transmissive type. Accordingly, a user may see an object located behind the body (of the device 200) through the transparent area of the body of the device 200 that is occupied by the display module 251.

The device 200 may also include at least two displays 251. For example, the device 200 may include a plurality of displays 251 that are arranged on a single face at a predetermined distance or integrated displays. The plurality of displays 251 may also be arranged on different sides.

When the display module 251 and a sensor sensing touch (hereafter referred to as a touch sensor) form a layered structure that is referred to as a touch screen, the display module 251 may be used as an input device in addition to an output device. The touch sensor may be in the form of a touch film, a touch sheet, and/or a touch pad, for example.

The touch sensor may convert a variation in pressure applied to a specific portion of the display module 251 or a variation in capacitance generated at a specific portion of the display module 251 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 280. Accordingly, the controller 280 may detect a touched portion of the display module 251.

The proximity sensor 242 of the sensing unit 240 may be located in an internal region of the device 200, surrounded by the touch screen, and/or near the touch screen. The proximity sensor may sense an object approaching a predetermined sensing face or an object located near the proximity sensor using an electromagnetic force or infrared rays without having mechanical contact. The proximity sensor may have a lifetime longer than a contact sensor and may thus have a wide application in the device 200.

The proximity sensor 242 may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor.

For ease of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor 242 may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen. A posture detection sensor 241 may also be included to detect a posture or orientation of the device 200.

The audio output module 252 may output audio data received from the wireless communication unit 210 or stored in the memory 260 in a call signal receiving mode, a telephone call mode or a recording mode, a speech recognition mode and a broadcasting receiving mode. The audio output module 252 may output audio signals related to functions, such as a call signal incoming tone and a message incoming tone, performed in the device 200. The audio output module 252 may include a receiver, a speaker, a buzzer, and/or the like. The audio output module 252 may output sounds through an earphone jack. The user may hear the sounds by connecting an earphone to the earphone jack.

The alarm module 253 may output a signal for indicating generation of an event of the device 200. For example, an alarm may be generated when receiving a call signal, receiving a message, inputting a key signal, and/or inputting a touch. The alarm module 253 may also output signals in forms different from video signals or audio signals, for example, a signal for indicating generation of an event through vibration. The video signals and/or the audio signals may also be output through the display module 251 or the audio output module 252.

The haptic module 254 may generate various haptic effects that the user may feel. One example of the haptic effects is vibration. An intensity and/or pattern of vibration generated by the haptic module 254 may also be controlled. For example, different vibrations may be combined and output or may be sequentially output.

The memory 260 may store a program for operations of the controller 280 and/or temporarily store input/output data such as a phone book, messages, still images, and/or moving images. The memory 260 may also store data about vibrations and sounds in various patterns that are output from when a touch input is applied to the touch screen.

The memory 260 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The device 200 may also operate in relation to a web storage that performs a storing function of the memory 260 on the Internet.

The interface unit 270 may serve as a path to external devices connected to the device 200. The interface unit 270 may receive data from the external devices or power and transmit the data or power to internal components of the device 200 or transmit data of the device 200 to the external devices. For example, the interface unit 270 may include a wired/wireless headset port, an external charger port, a wired/wireless data port, a memory card port, a port for connecting a device having a user identification module, an audio I/O port, a video I/O port, and/or an earphone port.

The interface unit 270 may also interface with a user identification module that is a chip that stores information for authenticating authority to use the device 200. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the device 200 through a port of the interface 270.

The interface unit 270 may also be a path through which power from an external cradle is provided to the device 200 when the device 200 is connected to the external cradle or a path through which various command signals input by the user through the cradle are transmitted to the device 200. The various command signals or power input from the cradle may be used as signals for confirming whether the device 200 is correctly set in the cradle.

The controller 280 may control overall operations of the device 200. For example, the controller 280 may perform control and processing for voice communication, data communication and/or video telephony. The controller 280 may also include a multimedia module 281 for playing multimedia. The multimedia module 281 may be included in the controller 280 or may be separated from the controller 280.

The controller 280 may perform a pattern recognition process capable of recognizing handwriting input or picture-drawing input applied to the touch screen as characters or images. The power supply unit 290 may receive external power and internal power and provide power required for operations of the components of the device 200 under control of the controller 280.

According to a hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 280.

According to a software implementation, embodiments such as procedures or functions may be implemented with a separate software module that executes at least one function or operation. Software code may be implemented according to a software application written in an appropriate software language. The software code may be stored in the memory 260 and executed by the controller 280.

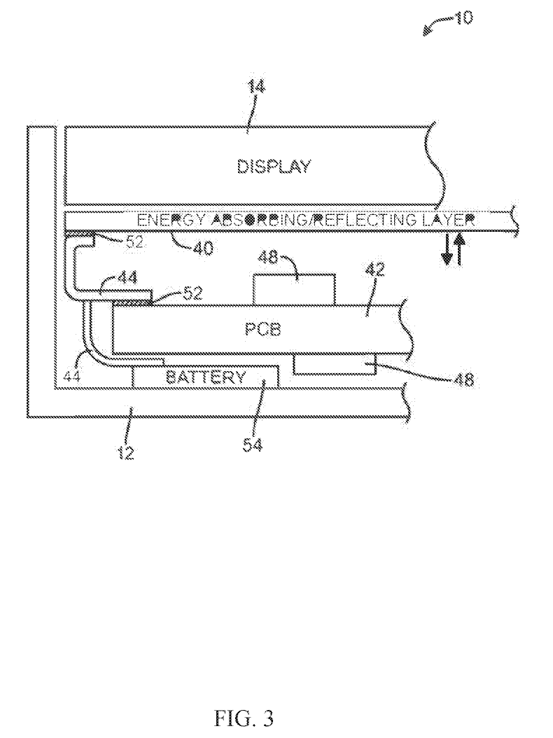

FIG. 3 is a cross-sectional view of a portion of electronic device 10 showing an energy absorbing and/or reflecting layer 40 that may be disposed behind a portion of display 14. Electronic device 10 may also include a circuitry, such as printed circuit board (PCB) 42. Circuitry associated with printed circuit board 42 (e.g., internal circuitry, circuitry on a surface of PCB 42, and/or integrated circuitry, such as circuit components 48 mounted to a surface of PCB 42) may control the operation of display 14 and other components of the device 10. PCB 42 and components 48 may, for example, include some or all of the wireless communication unit 210 of FIG. 2.

Energy released by the printed circuit board 42 and/or components 48 may be absorbed and/or reflected by the energy absorbing and/or reflecting layer 40 such that a user disposed on the opposite side of the display 14 may be exposed to no energy or reduced energy released from the PCB 42 and/or components 48. Attachment 44 may be used to secure the energy absorbing and/or reflecting layer 40 in place (e.g., anisotropic conductive film (ACF), solder, or other adhesive material 52). In another embodiment, the energy absorbing and/or reflecting layer 40 may be affixed directly to the display 14 with an adhesive.

The energy absorbing and/or reflecting layer 40 may be located near a portion of display 14. In one suitable example, the energy absorbing and/or reflecting layer 40 may be disposed along an edge of display 14, along substantially all of an inner surface of display 14, or in other discrete locations behind portions of display 14. The energy absorbing and/or reflecting layer 40 may be located such that energy released from the PCB 42 and/or components 48 may be absorbed and/or reflected prior to exiting the electronic device 10 through the display 14.

An exploded perspective view of an illustrative display of the type that may be used in the electronic device 10 is shown in FIG. 4. As shown in FIG. 4, display 14 may include display layers, including light-generating layers 14A, touch-sensitive layer 14B, and cover layer 14C. Display 14 may also include other layers of material, such as adhesive layers, optical films, or other suitable layers. Light-generating layers 14A may include image pixels 300 formed form light-emitting diodes (LEDs), organic LEDs (OLEDs), plasma cells, electronic ink elements, liquid crystal display (LCD) components, or other suitable image pixel structures compatible with flexible displays.

Touch-sensitive layer 14B may incorporate capacitive touch electrodes, such as horizontal transparent electrodes 320 and vertical transparent electrodes 340. Touch-sensitive layer 14B may, in general, be configured to detect the location of one or more touches or near touches on touch-sensitive layer 14B based on capacitive, resistive, optical, acoustic, inductive, or mechanical measurements, or any phenomena that may be measured with respect to the occurrences of the one or more touches or near touches in proximity to touch sensitive layer 14B.

Software and/or hardware may be used to process the measurements of the detected touches to identify and track one or more gestures. A gesture may correspond to stationary or non-stationary, single or multiple, touches or near touches on touch-sensitive layer 14B. A gesture may be performed by moving one or more fingers or other objects in a particular manner on touch-sensitive layer 14B, such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Cover layer 14C may be formed from plastic or glass (sometimes referred to as display cover glass) and may be flexible or rigid. If desired, the interior surface of peripheral portions of cover layer 14C may be provided with an opaque masking layer on such as black ink.

The energy absorbing and/or reflecting layer 40 may be attached to one or more of display layers 14A, 14B, and/or 14C. The energy absorbing and/or reflecting layer 40 may be configured to absorb and/or reflect energy that would otherwise exit the device 10 through cover layer 14C, through touch-sensitive layer 14B, and/or through one or more of light-generating layers 14A.

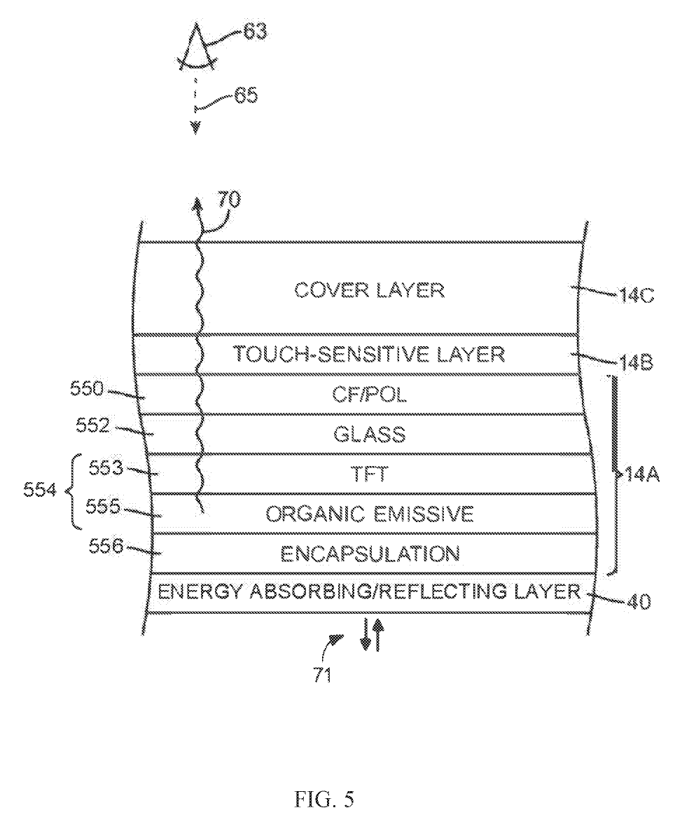

FIGS. 5, 6, and 7 show various configurations for light-generating layers 14A behind which the energy absorbing and/or reflecting layer 40 may be mounted.

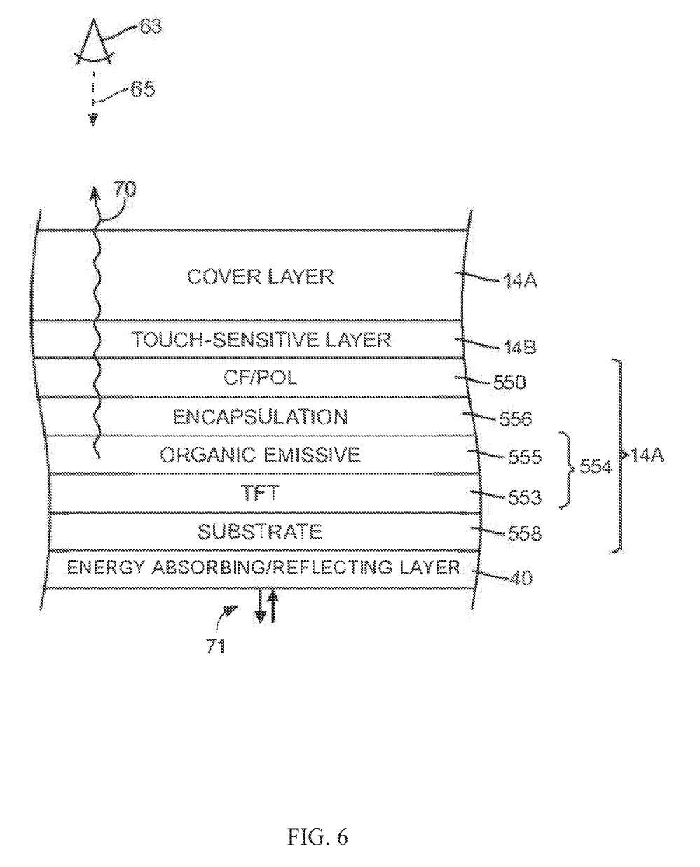

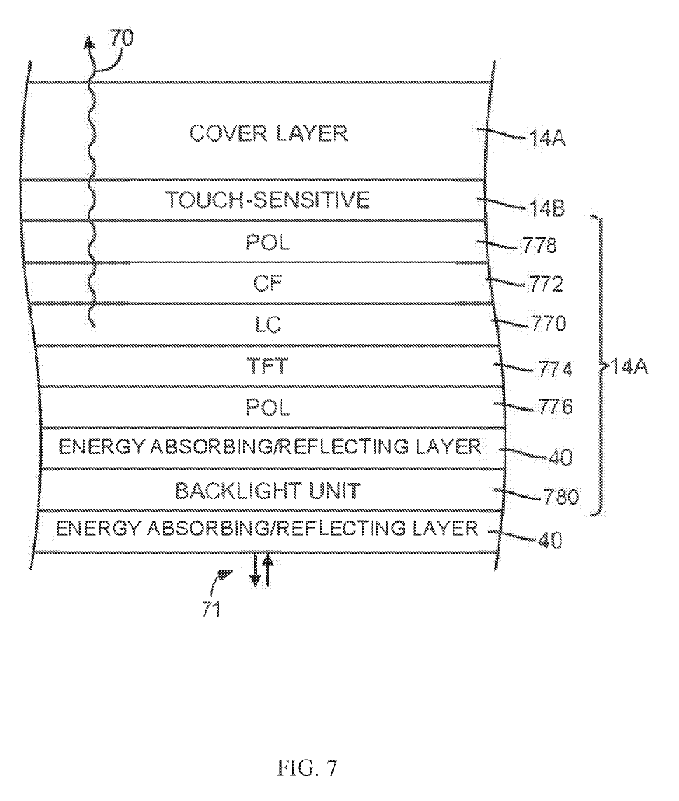

FIG. 5 is a cross-sectional view of an energy absorbing and/or reflecting layer 40 that may be mounted to light-generating layers 14A, which may be implemented as a bottom-emission organic light emitting diode (OLED) display. FIG. 6 is a cross-sectional view of an energy absorbing and/or reflecting layer 40 that may be mounted to light-generating layers 14A, which may be implemented as a top-emission organic light emitting diode (OLED) display. FIG. 7 is a cross-sectional view of an energy absorbing and/or reflecting layer 40 that may be mounted to light-generating layers 14A, which may be implemented as a liquid crystal display (LCD).

In a configuration for display 14 of the type shown in FIG. 5, light-generating layers 14A may include a transparent substrate layer, such as glass layer 552. A layer of organic light-emitting diode structures, such as organic light-emitting diode layer 554, may be formed on the underside of glass layer 552. An encapsulation layer, such as encapsulation layer 556, may be used to encapsulate organic light-emitting diode layer 554. Encapsulation layer 556 may be formed from a layer of metal foil, metal foil covered with plastic, other metal structures, a glass layer, a thin-film encapsulation layer formed from a material such as silicon nitride, a layered stack of alternating polymer and ceramic materials, or other suitable material for encapsulating organic light-emitting diode layer 554. Encapsulation layer 556 may protect organic light-emitting diode layer 554 from environmental exposure by preventing water and oxygen from reaching organic emissive materials within organic light-emitting diode layer 554.

Organic-light-emitting diode layer 554 may include thin-film transistor layer 553 and a layer of organic light-emitting material, such as emissive layer 555. Thin-film transistor layer 553 may include an array of thin-film transistors. The thin-film transistors may be formed from semiconductors, such as amorphous silicon, polysilicon, or compound semiconductors (as examples). Organic emissive layer 555 may be formed from organic plastics such as polyfluorene or other organic emissive materials. Encapsulation layer 556 may cover emissive layer 555 and, if desired, some or all of thin-film transistor layer 553.

During operation, signals may be applied to the organic light-emitting diodes in layer 554 using the signal lines so that an image is created on display 14. Image light 70 from the organic light-emitting diode pixels in layer 554 may be emitted upwards through transparent glass layer 552 for viewing in direction 65 by viewer 63. Color filter layer 550 may include a circular polarizer layer that suppress reflections from the metal signal lines in layer 554 that might otherwise be visible to viewer 63. The energy absorbing and/or reflecting layer 40 may be attached to encapsulation layer 556 and may absorb and/or reflect energy 71 that would otherwise pass through cover layer 14C, touch-sensitive layer 14B, and light-generating layers 14A. However, this is merely illustrative. The energy absorbing and/or reflecting layer 40 may be attached to any of display layers 14C, 14B, 550, 552, 553, 556, and/or other suitable display layers.

In a configuration for display 14 of the type shown in FIG. 6, light-generating layers 14A may include a substrate layer, such as substrate layer 558. Substrate layer 558 may be a polyimide layer that is temporarily carried on a glass carrier during manufacturing or may be a layer formed from glass or other suitable substrate materials.

Organic light-emitting diode layer 554 may be formed on the upper surface of substrate 558. An encapsulation layer, such as encapsulation layer 556, may encapsulate organic light emitting diode layer 554. During operation, individually controlled pixels in organic light emitting diode layer 554 may generate display image light 70 for viewing in direction 65 by viewer 63. Color filter layer 550 may include a circular polarizer layer that suppresses reflections from metal signal lines in layer 554. The energy absorbing and/or reflecting layer 40 may be attached to substrate 558 and may absorb and/or reflect energy 71 that would otherwise pass through cover layer 14C, touch-sensitive layer 14B, and light-generating layers 14A. However, this is merely illustrative. The energy absorbing and/or reflecting layer 40 may be attached to any of display layers 14C, 14B, 550, 553, 556, 558, and/or other suitable display layers.

In a configuration for display 14 of the type shown in FIG. 7, light-generating layers 14A may include a layer of liquid crystal material, such as liquid crystal (LC) layer 770. Liquid crystal layer 770 may be formed between color filter layer 772 and thin-film transistor layer 774. Layers 772 and 774 may be formed on a transparent substrate, such as a sheet of glass. Liquid crystal layer 770, color filter layer 772, and thin-film transistor layer 774 may be sandwiched between light polarizing layers, such as upper polarizer 778 and lower polarizer 776.

If desired, the energy absorbing and/or reflecting layer 40 may be attached to lower polarizer layer 776 and may absorb and/or reflect energy 71 that would otherwise pass through cover layer 14C, touch-sensitive layer 14B, upper polarizer 778 color filter layer 772, liquid crystal layer 770, thin-film-transistor layer 774, and lower polarizer layer 776.

In this type of configuration, the energy absorbing and/or reflecting layer 40 may be interposed between polarizer 776 and backlight structures, such as backlight unit 780 that may generate backlight for the liquid crystal display. However, this is merely illustrative. If desired, the energy absorbing and/or reflecting layer 40 may be attached to an interior surface of backlight unit 780 and may absorb and/or reflect energy 71 that would otherwise pass through cover layer 14C, touch-sensitive layer 14B, upper polarizer 778, color filter layer 772, liquid crystal layer 770, thin-film-transistor layer 774, and lower polarizer layer 776, and backlight unit 780. If desired, one or more energy absorbing and/or reflecting layers 40 may be affixed to any of cover layer 14C, touch-sensitive layer 14B, and/or any of layers 778, 772, 770, 774, 776, 780 or any other suitable display layers.

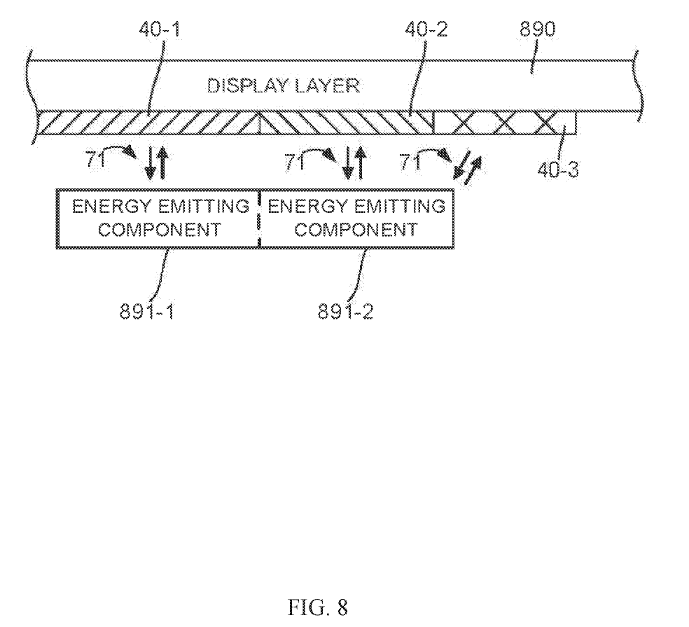

FIG. 8 is a cross-sectional view of a portion of device 10 showing how one or more energy absorbing and/or reflecting layers 40-1, 40-2, and 40-3 may be disposed between a display layer 890 and one or more energy emitting components 891-1 and 891-2, such as the wireless communication unit 210, including the one or more broadcasting receiving module 211, the mobile communication module 212, the wireless Internet module 213, the local area communication module 214, and/or the location information module 215 of FIG. 2. The energy absorbing and/or reflecting layers 40-1, 40-2, and 40-3 may be segmented portions of a common energy absorbing and/or reflecting layer or may be separate energy absorbing and/or reflecting layers.

The energy absorbing and/or reflecting layers 40-1, 40-2, and 40-3 may each block a respective portion of energy 71 from passing through the display layer 890 and reaching a user. The energy absorbing and/or reflecting layers 40-1, 40-2, and 40-3 and, if desired, additional energy absorbing and/or reflecting layers may be formed on the display layer 890. Display layer 890 may, for example, represent cover layer 14C or color filter layer 74.

The example of FIG. 8 in which the energy absorbing and/or reflecting layers 40-1, 40-2, and 40-3 may be configured to absorb and/or reflect energy by mounting the energy absorbing and/or reflecting layers between the display layer 890 and specific energy emitting components 891-1 and 891-2 is merely illustrative. If desired, each energy absorbing and/or reflecting layers 40-1, 40-2, and 40-3 may itself be configured to block and/or reflect a specific type of energy. For example, the energy emitting component 891-1 may be the local area communication module 215 that emits low-intensity microwave radiation and the energy absorbing and/or reflecting layer 40-1 may be specifically configured to absorb and/or reflect low-intensity microwave radiation.

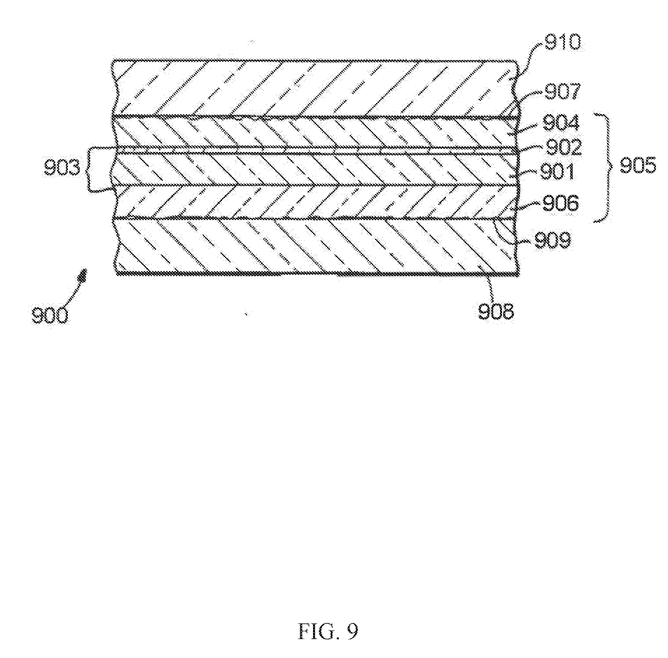

Referring now to FIG. 9, an energy (e.g., electromagnetic, including but not limited to radio waves, micro waves, infrared waves, and the like) absorbing and/or reflecting glass laminate 900 (electronic device screen) is shown. The laminate 900 may comprise a substrate layer 901. This substrate layer 901 may serve as a carrier for coatings 902, and together substrate 901 and coatings 902 may comprise an energy control film 903 (energy absorbing and/or reflecting layer 40). Substrate 901 may be a flexible, transparent plastic material, that has suitable thermal characteristics to maintain its integrity and transparency under the conditions employed in the subsequently described coating, bonding and laminating steps. The substrate material may also be chosen to provide a refractive index that is close to that of glass. Known materials of this class exhibit varying amounts of minute wrinkling under the outlined processing conditions and the disclosed methods reduce such wrinkling.

Among the suitable film forming plastic materials for substrate 901 are biaxially oriented polyesters, such as polyethylene terephthalate (PET), nylons, polyurethanes, acrylics, polycarbonates, polyolefins such as polypropylenes, cellulose acetates and triacetates, vinyl chloride polymers and copolymers and the like.

The thickness of substrate 901 may depend on the particular application. In general, the substrate 901 may vary from about 0.01 to 0.6 mm (about 10-600 microns). Substrate 901 may require some form of treatment to render its surfaces suitable for adhesion to the abutting materials. As indicated above, one surface of substrate 901 may support energy coating 902. The first of these coating layers, as described below, may be a dielectric material (e.g., a metal oxide, which generally may be deposited in adherent fashion without any need for substrate priming or adhesion promoting). The opposing surface of substrate 901 may be bonded to a safety film, e.g., PVB. In this circumstance, an adhesion promotion treatment may be carried out on the substrate surface. This treatment may take any number of forms, such as coating the substrate surface with a thin (e.g., 50 angstroms) non-optical coating of a dielectric material; coating the substrate surface with an adhesive; coating the substrate surface with chemical primers such as silanes; treating of the substrate surface by flame or by plasma or electron beam energy in a reactive atmosphere, and the like. In an embodiment, an adhesion promoting coating (e.g., dielectric or adhesive) with desirable optical properties, such as an antireflecting layer, may be applied to aid in achieving a desired refractive index match.

Energy control film 903 may be prepared by applying a multilayer coating 902 to substrate 901. Coating 902 may be optically functional as an interference coating which serves to enhance visible transmission while reflecting radiation. In accordance with one embodiment, the optical properties of energy control film 903 may be controlled to provide overall characteristics of the glass laminate 900 which mask the prominence of wrinkles in the substrate layer which detract from the appearance of the laminate 900.

In general, the contribution which the energy control film 903 may make to visible reflectance of the complete laminate 900 may be about 2% or less (based on total incident visible radiation). The contribution to reflection of visible light produced by the energy control film 903 may be one percent or less. The visible light reflection contribution of the remainder of the laminate 900 may be around eight percent, giving a total visible light reflection of ten percent or less. The reflectance contribution values specified herein refer to observations from one or both sides of the laminate 900.

A method of achieving low visible reflectance contribution of the energy film in the laminate 900 may be accomplished by providing a specially-designed energy coating. It is also possible, as described below, to aid in achieving this objective by employing absorbing materials between the energy coating layers and the observer.

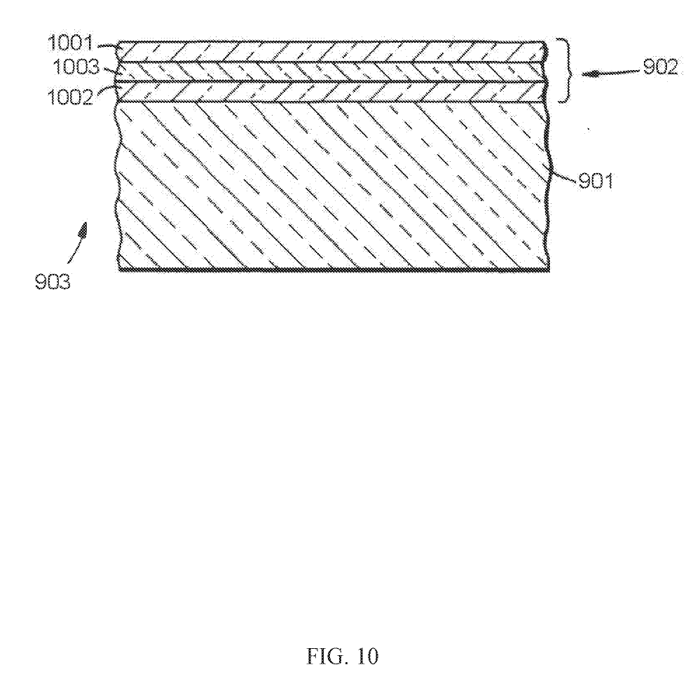

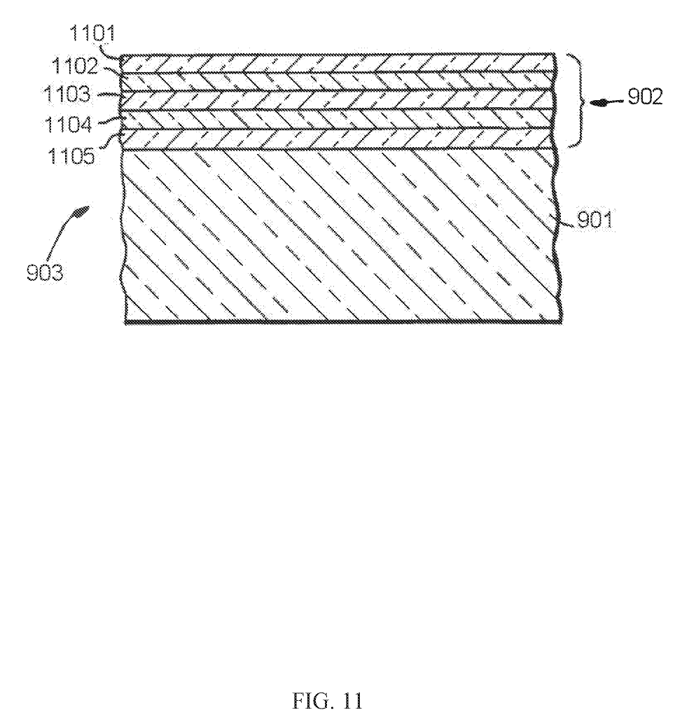

The energy coating 902 will now be described with reference to FIGS. 10 and 11. The energy coating 902 may comprise 1) at least one thin electrically conductive, near infrared or other electromagnetic reflecting metal layer, and 2) at least one adjacent adherent layer of a dielectric material. These layers, which when operatively positioned in the coating, may contribute the required low visible reflection. The energy coating 902 may comprise a three-layer coating of the type shown in FIG. 10. In this embodiment energy coating 902 may comprise dielectric layers 1001 and 1002 on either side of metal layer 1003. This basic stack of three layers may be doubled to give a five-layer design of the type shown in FIG. 11. In FIG. 11, layers 1101, 1103, and 1105 may be dielectric layers, and layers 1102 and 1104 may be metal layers. This is a 2× multiple of the three-layer because layer 1103, while a single material is really two layers, the top of one three-layer stack and the bottom of another. This arrangement, employing two or more spaced metal layers, may result in an interference filter of the Fabry-Perout type. Similarly, a seven-layer stack may be formed using three of the basic stack modules. The higher multiple stacks (e.g., five-layer, seven-layer, nine-layer, etc.) generally may be more desirable since they provide higher total energy rejection while maintaining acceptable low visible reflection.

Among the suitable metals for the metal layer(s) are silver, palladium, aluminum, chromium, nickel, copper, gold and alloys thereof as well as other alloys such as brass and stainless steel. Silver may be used for optical purposes. Metal layer 1003 (FIG. 10) and metal layers 1102 and 1104 (FIG. 11) should be continuous, and thereby, highly conductive to maximize both electrical characteristics and near energy reflection. The metal layer(s) should be relatively thin to reduce reflected color, which may be particularly undesirable at oblique viewing angles. When used with known dielectrics of high refractive index as hereinafter described, the thickness of metal layers 1003, 1102 and 1104 may generally be in the range of about 30 to 180 angstroms. This use of relatively thin metal layers, may result in a concomitant decrease in energy reflection.

Energy coating 902 may also comprise one or more dielectric layers shown in FIG. 10 as 1001 and 1002, and FIG. 11 as 1101, 1103, and 1105. These layers, conventionally employed in energy control films, may be essentially transparent over the solar range (e.g., from 325 to 2125 nm).

In general, the dielectric material may be chosen with a refractive index which is greater than the material outside the coating it abuts. For example, dielectric layer 1002 of FIG. 10 may abut the substrate 901 (e.g., PET, which has a refractive index of about 1.64). Similarly, dielectric layer 1001 may abut a layer of safety film 904 (e.g., PVB, which has a refractive index of about 1.5) as shown in FIG. 9. In general, a higher refractive index of the dielectric layers may be desired. Dielectric materials with a refractive index of greater than about 1.8 may be employed, for example, above about 2.0. Dielectric layers upon which a metal layer may be deposited, e.g., layers 1002 of FIG. 10 and layers 1105 and 1103 of FIG. 11, may also be chosen to provide a suitable surface for this coating operation. Suitable dielectric materials for layers 1001, 1002, 1101 and 1105 may include, but are not limited to, ZrO₂, T₂O₅, WO₃, In₂, O₃, SnO₂, In/SnOₓ, Al₂O₃, ZnS, ZnO and TiO₂. In the embodiment of FIG. 11, the refractive index of layer 1103, which serves as a spacer layer for metal layers 1102 and 1104, may not be as critical as that for layers 1101 and 1105. Accordingly, dielectric materials, such as SiO, SiO₂ and MgF₂, in addition to those listed above, may be used for this spacer layer. In an embodiment, the refractive index may be above about 1.5 for the spacer layer.

The thickness of the dielectric layers may be chosen to obtain an optical which provides maximum reflection suppression: 1) in the 390-750 nm wavelength region for energy in the visible spectrum; 2) in the 750 nm-1 mm wavelength region for energy in the infrared spectrum; 3) in the 1 mm-1 m wavelength region for energy in the microwave spectrum; and 4) in the 1 mm-1 km wavelength region for energy in the radio spectrum. Depending on the particular dielectric material chosen, this may comprise a dielectric layer of from about 200-600 angstroms. An example three-layer construction of the type shown in FIG. 10 may comprise:

| Layer | Material | Thickness |
|---|---|---|
| Layer 1001 | WO₃ | 400 angstroms |
| Layer 1002 | Ag | 90 angstroms |
| Layer 1003 | WO₃ | 400 angstroms |

The same basic design criteria may apply to the five-layer coatings shown in FIG. 11. Spacer layer 1103 between the two metal layers generally may be about twice the thickness of other dielectric layers (e.g., 400-1200 angstroms). An example five-layer construction of the type shown in FIG. 11 may comprise:

| Layer | Material | Thickness |
|---|---|---|
| Layer 1101 | WO₃ | 40 angstroms |
| Layer 1102 | Ag | 90 angstroms |
| Layer 1103 | WO₃ | 800 angstroms |
| Layer 1104 | Ag | 90 angstroms |
| Layer 1105 | WO₃ | 400 angstroms |

Individual layers of the energy coating may be deposited by vacuum coating techniques well known in the art, such as vacuum evaporation or sputtering. Usable methods may include evaporation (resistance heated, laser heated, or electron-beam vaporization) and DC or RF sputtering (diode or magnetron) under normal or reactive conditions.

After preparation of energy control film 903, in an example embodiment, the energy control film 903 may be bonded to at least one layer of safety film of the type normally used in glass or shatterproof laminated windows to form a composite energy/safety film 905 (FIG. 9). The function of this safety film is to absorb energy of impact on the laminate 900 and prevent glass from flying off the laminate 900 after it is broken.

The functional requirements of this safety film include (1) good adhesiveness to glass, (2) good modulus of elasticity, (3) good refractive index match for glass (e.g., near 1.5), (4) good optical clarity, and (5) good optical stability over the useful life of the window.

Among the suitable flexible transparent plastic film-forming materials for this safety film include plasticized polyvinyl butyral (PVB), polyurethanes, polyvinyl chloride, polyvinyl acetal, polyethylene, ethylene vinyl acetates, and the like.

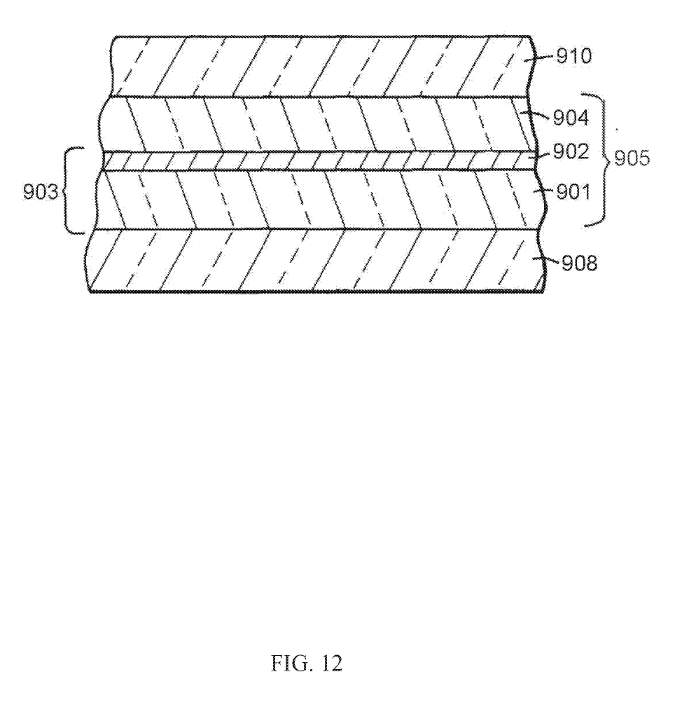

The composite energy/safety film 905 is shown in FIG. 9 may be a sandwich of the energy control film 903 encapsulated between two safety film sheets 906 and 907. In an alternative embodiment shown in FIG. 12, composite energy/safety film 905 may comprises energy control film 903 and bonded to one surface thereof, safety film 904. In this embodiment, substrate 901 of energy control film 903 may be bonded directly to glass layer 908 with, for example, a suitable transparent adhesive. In an embodiment where the substrate is PET, adhesives which may be employed include polyester adhesives, polyamide resin adhesives, and a wide variety of vinyl resin-based adhesives used in the glass construction industry. In other embodiments, the composite energy/safety film 905 of the type shown in FIG. 12, may be laminated directly to a single piece of glass or to a conventional glass laminate (e.g., a glass/PVB/glass laminate). In these last two embodiments, it may be necessary to include on the back side of the energy film substrate 901 (i.e., side opposite the energy coating 902), an antireflecting coating layer(s). In any of the embodiments described herein, the use of antireflecting coatings on the substrate backside may be employed to further lower the reflectance contribution of the energy control film 903. The interface between PET and PVB, for example, may produce a reflectance contribution increase of about 0.3%, due to refractive index mismatch. PET interfaces with other materials, e.g. air, may result in different values. In a known manner, the thickness of the antireflective layer may be specified based on its refractive index in accordance with the following equation (for the PET/PVB interface): n=\sqrt{n_{PET}×n_{PVB}}.

Using this equation may result in a refractive index of 1.55. Using a material with a refractive index of 1.55 in order to obtain a quarter wavelength antireflection filter at 550 nm, the antireflection layer would need to be approximately 887 angstroms thick.

Safety films 906 and 904 may be provided as manufactured with one rough surface 909 or 907 and the opposite surface being relatively smooth. See U.S. Pat. No. 4,654,179, incorporated herein by reference. The resulting rough outer surface of the composite energy/safety film 905 may permit optimum lamination to glass layers 910 and 908 by providing escape pathways for air entrapped between the layers during the conventional lamination process described below.

In the embodiment shown in FIG. 9 it may not be necessary for safety film layers 906 and 904 to be of the same thickness, or even the same material. The thickness of each safety film layer may vary with design, for example, from about 0.1 to 0.3 mm (100-300 microns).

In one embodiment, the contribution to visible reflection of the energy control film 903 after incorporation into the final laminate 900 may be kept below about 2.0% by including an absorbing element between the observer and the energy control film 903. One way to accomplish this objective may be to include a dye or pigment in the safety film, on one side or both, or in one or both of the glass layers. Another absorption approach may involve the use of vapor deposited absorption coatings, e.g., thin layers of certain metals such as tungsten, nickel or chromium. The visible light absorbing coating may alternatively be deposited on the substrate layer 901 or the energy coating 902.

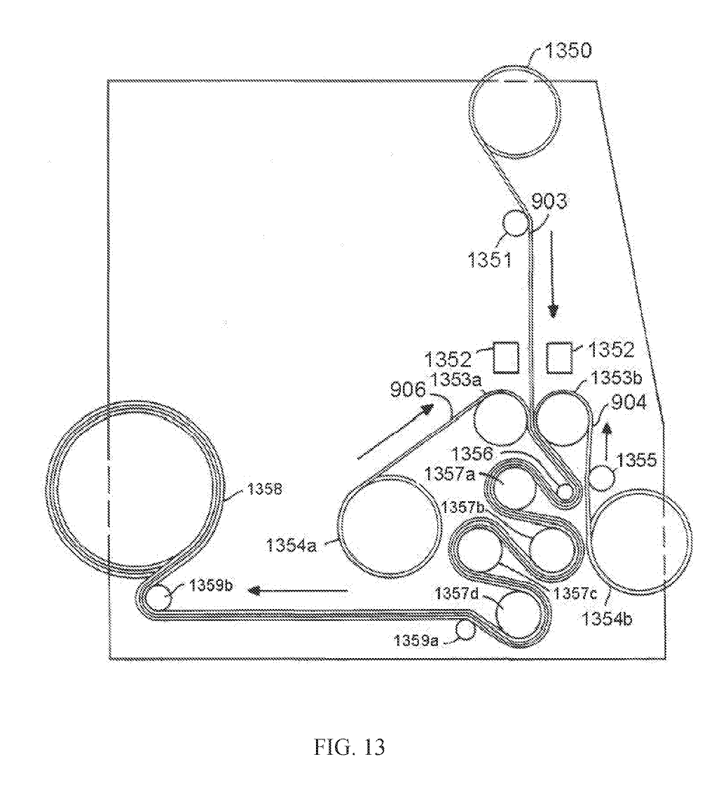

Formation of the composite energy/safety film 905 will now be described in connection with FIG. 13. In general, the energy control film 903 (e.g., five-layer coated PET) may be encapsulated, e.g., lightly bonded, between two layers of safety film 906 and 904 (e.g., PVB) in a nip roll bonding process. The energy control film 903 may be supplied from roll 1350 and first passes over tension roll 1351. The energy control film 903 may then be subjected to moderate surface heating at stations 1352. Heating stations 1352 may be positioned to heat either the energy control film 903, the PVB sheets, or both. Heating may be to a temperature sufficient to promote temporary fusion bonding, i.e., the surfaces of the PVB become tacky. Suitable temperatures for the preferred materials may be in the range of 120° to 250° F., for example, about 150° F.

The energy control film 903 may then be fed along with PVB layers 906 and 904 to nip rolls 1353a, 1353b (which are rotating in opposite directions), where the three layers may be merged together under moderate pressure to form a weakly bonded composite energy/safety film. The PVB sheets may be supplied by rolls 1354a, 1354b and the supply line may include tension rolls such as shown at 1355. If desired, nip rolls 1353a, 1353b also may be heated to promote the bonding process. The bonding pressure exerted by the nip rolls may vary with the film materials and temperature employed, but generally may range from about 10-75 psi, for example, about 25-30 psi.

The tension of the composite energy/safety film 905 may be controlled by passage over idler roll 1356. Typical line speeds through the roll assembly may be in the range of five to thirty feet per minute. Proper control of speed and tension helps to minimize wrinkling of the PET substrate of the energy film.

After bonding between nip rolls, the weakly bonded composite energy/safety film 905 may be passed over a series of cooling rolls 1357a, 1357b, 1357c, 1357d, which ensure that the product taken up on roll 1358 is not tacky. Process water cooling is generally sufficient to achieve this objective. Tension in the system may be further maintained by idler rolls 1359a and 1359b.

The resulting composite energy/safety film 905 may have a bond strength of about 2-5 pounds per linear inch when tested according to the standard 180° peel test. This should be sufficient to avoid delamination during normal handling of the composite energy/safety film 905. This composite energy/safety film 905 may be provided to a laminator to complete the assembly process as described below.

The final component of the laminated electronic device screen assembly is the outer layer(s) of rigid transparent material shown in FIG. 9 at 910 and 908. Layers 910 and 908 may be made of glass but rigid transparent plastics such as polycarbonates, acrylics and the like may also be employed.

The final step in the process may be a lamination step, in which the composite energy/safety film 905 may be laminated to at least one rigid transparent member. In embodiment shown in FIG. 9, the laminate may comprise a sandwich of the composite energy/safety film 905 between two glass layers 910 and 908.

The composite energy/safety film 905 has the advantage that it may be used in the same manner, and laminated employing the same equipment as that employed in forming conventional glass laminates, e.g., containing a single layer PVB safety film. The typical commercial glass lamination process may comprise (1) laying up the three layer assembly, (2) passing the assembly through a pair of nip rolls at room temperature to expel trapped air, (3) heating the assembly, typically to about 100° C., for a short period, e.g., about 20 minutes, (4) passing the hot assembly through a second pair of nip rolls to give the assembly enough temporary adhesion to handle and (5) autoclaving the assembly typically at 260° to 300° F. and 160 to 190 psi for about 10 to 30 minutes. It may not be possible to press out, or otherwise eliminate, wrinkles in the energy film substrate 901, which may adversely affect the product quality. However, the ability of an observer to see wrinkles in the substrate layer 901 may be significantly reduced by limiting the contribution to the total laminate reflection made by the energy control film 903 to a prescribed low value. In an embodiment, the reflectivity contribution of the energy control film 903 to the total laminate reflectance may be reduced by controlling the nature of the energy coating 902 on the substrate 901. For example, visible reflectance contribution of the energy control film 903 may be reduced by using thinner metal layers and by using dielectric materials with higher refractive indices, and by judicious selection of dielectric thicknesses to ensure that reflection suppression occurs at appropriate wavelengths in the visible region. The observed contribution of the energy control film 903 may also be lowered to the desired level by placing an absorbing material between the observer and the energy control film 903.

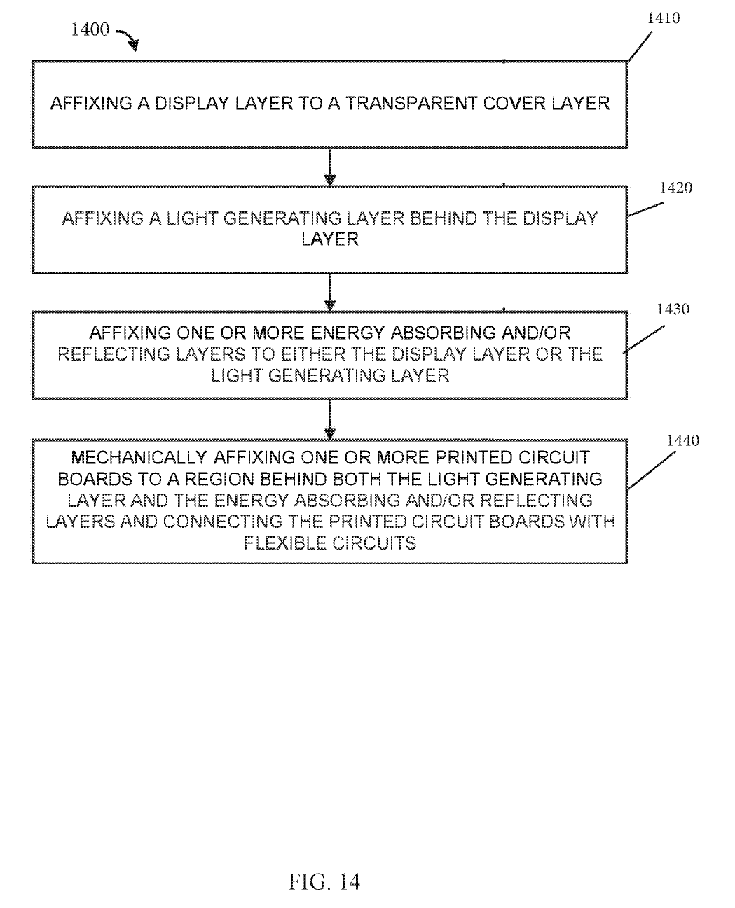

In an embodiment, illustrated in FIG. 14, a method 1400 is disclosed for assembling an electronic device with an energy absorbing and/or reflecting layer. The method 1400 may comprise affixing a display layer to a transparent cover layer at 1410. The method 1400 may comprise affixing a light generating layer behind the display layer at 1420. The method 1400 may comprise affixing one or more energy absorbing and/or reflecting layers to either the display layer or the light generating layer at 1430. The method 1400 may comprise mechanically affixing one or more printed circuit boards to a region behind both the light generating layer and the energy absorbing and/or reflecting layers, and connecting the printed circuit boards with flexible circuits at 1440.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. An electronic device comprising:
a housing configured to at least partially surround the electronic device;
a multi-layered display disposed within the housing, wherein the multi-layered display is configured to display images thereon;
at least one energy absorbing/reflecting layer affixed to at least a portion of the multi-layered display, wherein the at least one energy absorbing/reflecting layer comprises,
a flexible, transparent substrate layer comprising a carrier surface and an opposing back surface,
a multilayer energy control coating disposed on the carrier surface, wherein the multilayer energy control coating is configured to absorb or reflect at least a portion of energy within or below a Gigahertz frequency range, and minimize energy absorption and reflection in a Terahertz frequency range, and
at least one flexible, transparent, energy absorbing safety layer disposed on at least one of the back surface of the substrate layer, the multilayer energy control coating, and combinations thereof; and
at least one energy emitting component disposed within the housing behind the multi-layered display, wherein the at least one energy emitting component is configured to emit energy within or below a Gigahertz frequency range, wherein at least a portion of the energy emitted therefrom is absorbed or reflected by the at least one energy absorbing/reflecting layer.

2. The electronic device of claim 1, wherein the multi-layered display comprises at least one light-generating layer, a touch-sensitive layer, and a cover layer.

3. The electronic device of claim 2, wherein the at least one energy absorbing/reflecting layer is affixed to at least a portion of the cover layer of the multi-layered display.

4. The electronic device of claim 1, wherein the multilayer energy control coating comprises at least one layer of a metallic material.

5. The electronic device of claim 4, wherein the at least one layer of metallic material is selected from the group consisting of silver, palladium, aluminum, chromium, nickel, copper, gold, brass, stainless steels, and alloys thereof, and combinations thereof.

6. The electronic device of claim 1, wherein the multilayer energy control coating comprises at least one layer of dielectric material.

7. The electronic device of claim 6, wherein the at least one layer of dielectric material is selected from the group consisting of ZrO₂, Ta₂O₅, WO₃, In₂O₃, SnO₂, In/SnOₓ, Al₂O₃, ZnS, ZnO, and TiO₂.

8. The electronic device of claim 1, wherein the multilayer energy control coating comprises at least three layers, wherein the three layers are configured as a first layer of dielectric material, a layer of metallic material, and a second layer of dielectric material.

9. The electronic device of claim 1, wherein the multilayer energy control coating comprises at least five layers, wherein the five layers are configured as a first layer of dielectric material, a first layer of metallic material, a second layer of dielectric material, a second layer of metallic material, and a third layer of dielectric material.

10. The electronic device of claim 1, wherein the transparent substrate layer is selected from the group consisting of biaxially oriented polyesters, nylons, polyurethanes, acrylics, polycarbonates, polyolefins, cellulose acetates and triacetates, vinyl chloride polymers and copolymers, and combinations thereof.

11. The electronic device of claim 1, wherein the at least one safety layer is selected from the group consisting of plasticized polyvinyl butyral, polyurethanes, polyvinyl chloride, polyvinyl acetal, polyethylene, ethylene vainly acetates, and combinations thereof.

12. An apparatus, comprising:
a multi-layered display configured to display images thereon, wherein the multi-layered comprises,
a cover layer comprising at least one transparent region and at least one opaque region,
a touch-sensitive layer positioned behind at least one transparent region of the cover layer, and
a light-generating layer affixed behind the touch-sensitive layer;
at least one energy emitting component positioned behind the light-generating layer, wherein the at least one energy emitting component is configured to emit energy within or below a Gigahertz frequency range; and
at least one energy absorbing/reflecting layer positioned between the cover layer and at least one energy-emitting component, wherein at least a portion of the energy emitted from the at least one energy emitting component is absorbed or reflected by the at least one energy absorbing/reflecting layer.

13. The apparatus of claim 12, wherein at least one energy absorbing/reflecting layer is positioned between the light-generating layer and at least one energy-emitting component.

14. The apparatus of claim 12, wherein the at least one energy absorbing/reflecting layer minimizes absorption or reflection of energy in the 430 to 770 Terahertz range.

15. The apparatus of claim 12, wherein the at least one energy absorbing/reflecting layer absorbs or reflects a specific type of energy.

16. The apparatus of claim 12, wherein the light-generating layer comprises a liquid crystal display.

17. The apparatus of claim 12, wherein the light-generating layer comprises an organic light-emitting diode display.

18. The apparatus of claim 12, wherein at least one energy-emitting component is a printed circuit board.

19. An apparatus, comprising:
a cover layer comprising at least one transparent region and at least one opaque region;
a display layer positioned behind at one transparent region of the cover layer;
a light-generating layer positioned behind the display layer;
at least one energy emitting component positioned behind the light-generating layer, wherein the at least one energy emitting component is configured to emit energy within or below a Gigahertz frequency range; and
at least one energy absorbing/reflecting layer positioned between the display layer and at least one energy-emitting component, wherein at least a portion of the energy emitted from the at least one energy emitting component is absorbed or reflected by the at least one energy absorbing/reflecting layer.

20. The apparatus of claim 19, wherein the at least one energy absorbing/reflecting layer comprises:
a flexible, transparent substrate layer comprising a carrier surface and an opposing back surface;
a multilayer energy control coating disposed on the carrier surface, wherein the multilayer energy control coating is configured to absorb or reflect at least a portion of energy within or below a Gigahertz frequency range, and minimize energy absorption and reflection in a Terahertz frequency range; and
at least one flexible, transparent, energy absorbing safety layer disposed on at least one of the back surface of the substrate layer, the multilayer energy control coating, and combinations thereof.
